(19) United States
(12) Patent Application Publication
(10) Pub. No.: US 2015/0286049 A1
(43) Pub. Date: Oct. 8, 2015

(54) MICRO-ELECTRO-MECHANICAL SYSTEM MIRROR AND MICRO-ELECTRO-MECHANICAL SYSTEM REFLECTIVE DEVICE

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 14/271,464

(22) Filed: May 7, 2014

(30) Foreign Application Priority Data
May 9, 2013 (TW) 102116564

(51) Int. Cl. G02B 26/08; G02B 6/35

(52) U.S. Cl. CPC G02B 26/0841; G02B 6/3518

(57) ABSTRACT

A micro-electro-mechanical system mirror comprises a reflective mirror and a number of MEMS driving modules. A number of driving shafts extend from a side surface of the mirror body, each driving shaft being connected to a driving module. Each driving module comprises a container of liquid, an optical fiber, and a light source. The container includes a main body having an opening sealed with a film. The sealing film is arranged toward the driving shaft and seals in the liquid in the container. An optical fiber is inserted into the through holes in the main body of the container and a light source is arranged at the other end of the optical fiber. Light arriving through the optical fiber causes the liquid to expand and deform the sealing film to push against and thus orientate the mirror body.

### FIELD

The present disclosure relates to a Micro-Electro-Mechanical System (MEMS) mirror and a MEMS reflective device.

### BACKGROUND

MEMS mirrors are widely used in a variety of electronic devices, such as barcode readers, laser printers, confocal microscopes, projection displays and rear projection televisions.

An electrostatic MEMS mirror includes a reflective mirror, a first electrode, and a second electrode. A voltage is applied to the first electrode or the second electrode, and an electrostatic attraction is produced between the first electrode and the reflective mirror or between the second electrode and the reflective mirror. The electrostatic attraction makes a reflective surface of the reflective mirror rotate towards the first electrode or the second electrode.

### BRIEF DESCRIPTION OF THE DRAWINGS

FIG. 1 is a plan view of an embodiment of a MEMS reflective device, including a MEMS mirror.

FIG. 2 is a plan view of the MEMS mirror of FIG. 1.

FIG. 3 is a sectional view of the MEMS mirror along line III-III direction of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the disclosure will be described, with reference to the accompanying drawings.

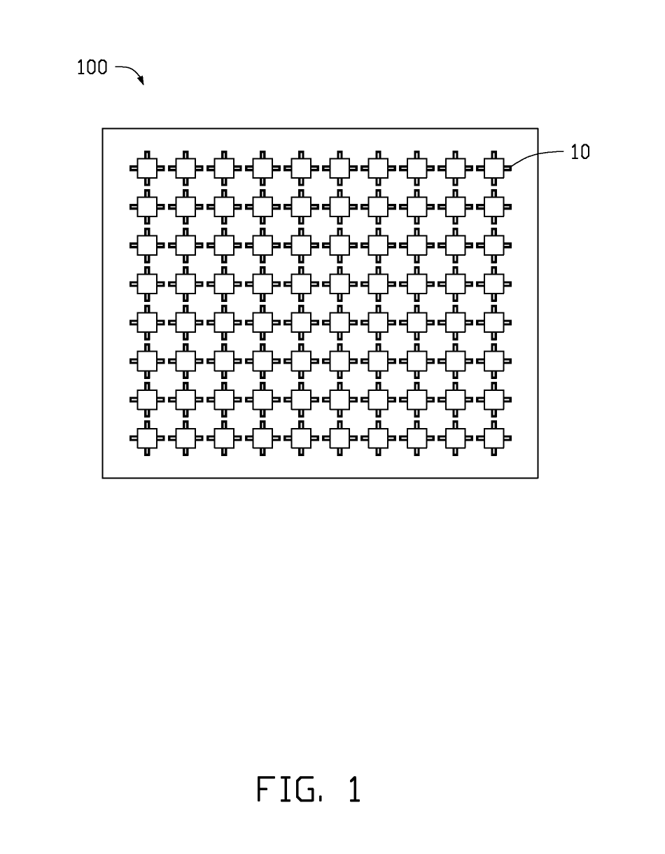

FIG. 1 illustrates an embodiment of a MEMS reflective device 100. The MEMS reflective device 100 includes a number of MEMS mirrors 10 arranged in an array. In one embodiment, the MEMS mirrors 10 are arranged in an 8×10 array.

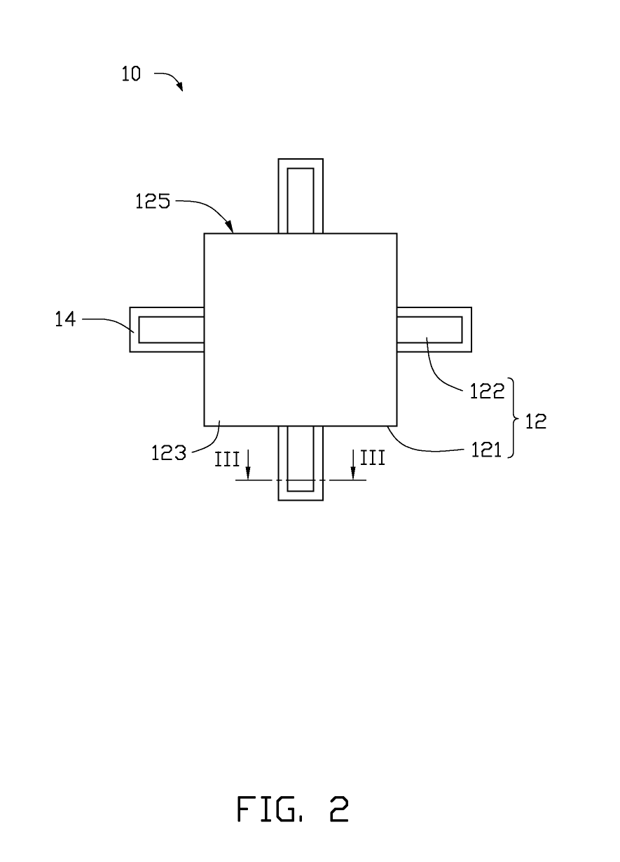

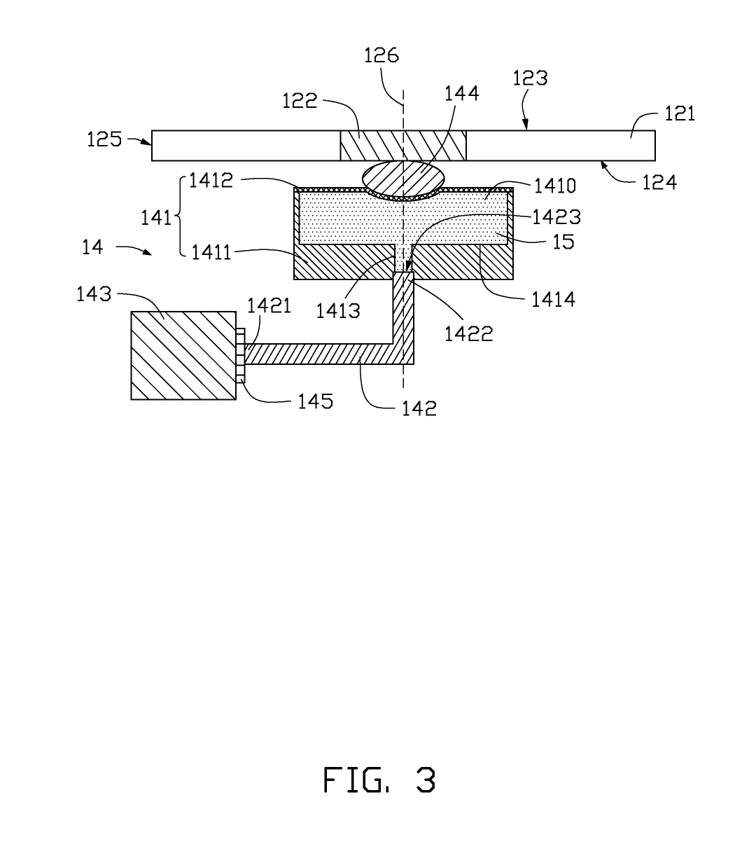

FIG. 2 and FIG. 3 illustrate one MEMS mirror 10 which includes a reflective mirror 12 and four MEMS driving modules 14. The MEMS drive modules 14 are configured to drive the reflective mirror 12.

The reflective mirror 12 includes a mirror body 121 and four driving shafts 122. The mirror body 121 is substantially square. The mirror body 121 includes a top surface 123, a bottom surface 124, and four side surfaces 125. The top surface 123 and the bottom surface 123 are positioned at opposite sides of the mirror body 121, and the top surface 123 is substantially parallel to the bottom surface 123. The top surface 123 is a reflective surface. The side surfaces 125 interconnect the top surface 123 and the bottom surface 124. The side surfaces 125 are substantially perpendicularly connected to each other end-to-end. The four driving shafts 122 correspond to the four side surfaces 125. Each driving shaft 122 extends from a side surface 125. In one embodiment, an extending direction of each driving shaft 122 is substantially perpendicular to and intersects a central axis 126 of the mirror body 121. The driving shafts 122 are substantially equidistant from each other around the central axis. Each driving shaft 122 can be a strip or bar having a rectangular cross-section.

The four MEMS driving modules 14 correspond to the four drive shafts 122. The four MEMS driving modules 14 each have the same structure. Each MEMS driving module 14 includes a container 141, an optical fiber 142, a light source 143, and a contact member 144.

The container 141 includes a main body 1411 having an opening 1410 and a sealing film 1412. The main body 1411 is made of a rigid material. The sealing film 1412 is made of a flexible material. The main body 1411 defines a cavity 1414 for receiving liquid 15 and a through hole 1413 communicating with the cavity 1414. The opening 1410 and the through hole 1413 are positioned at opposite ends of the cavity 1414. The sealing film 1412 covers the opening 1410. The sealing film 1412 is arranged to face a side of the drive shafts 122 adjacent to the bottom surface 124 of the mirror body 121. The sealing film 1412 and the liquid 15 are in contact with each other. When the liquid 15 is expanded with heat and contracted with cold, the rigid main body 1411 remains unchanged, and the flexible sealing film 1412 deforms to accommodate a change in the volume of the liquid 15. A light output end 1422 of the optical fiber 142 is inserted into the through holes 1413. The light output end 1422 cooperates with the sealing film 1412 to seal the cavity 1414.

The optical fiber 142 includes a light incident end 1421 and the light output end 1422. The optical fiber 142 further includes a light output surface 1423 at the light output end 1422. In one embodiment, the light output surface 1423 is located in the through holes 1413. The light incident end 1421 is arranged toward the light source 143 to receive light emitted from the light source 143. Light emitted from the light source 143 enters the optical fiber 142 through the light incident end 1421 and is emitted out of the optical fiber 142 through the light output surface 1423 at the light output end 1422. The drive module 14 can further include an optical switch 145. The optical switch 145 is located between the light source 143 and the light incident end 1421 to allow or prevent light emitted from the light source 143 to enter the light incident end 1421. In one embodiment, the light source 143 is a light emitting diode (LED).

The four contact members 144 correspond to the four driving shafts 122. Each contact member 144 is positioned on the sealing film 1412 and supports the bottom surface 124 of a drive shaft 122. The contact member 144 can be cylindrical in shape, polygon, ellipsoid or spherical. In one embodiment, the contact member 144 is made of rigid material. A cross section of the contact member 144 can be substantially an ellipse with a major axis. The major axis is parallel to the bottom surface 124 and the side surface 125. The contact member 144 decreases the contact area between the sealing film 1412 and the drive shaft 122, thereby promoting more significant movement of the drive shaft 122 when the sealing film 1412 deforms.

When the mirror body 12 is to be deflected or tilted, a driving signal is applied to one of the four MEMS driving modules 14 or two neighboring MEMS driving modules 14 of the four MEMS driving modules 14. The corresponding optical switch 145 is open. Light emitted from the light source 143 enters the optical fiber 142 through the light incident end 1421 and is emitted out of the optical fiber 142 through the light output surface 1423 towards the cavity 1414. The liquid 15 in the cavity 1414 expands as it is heated from the light emitted from the light output surface 1423. The sealing film 1412 deforms to push the contact member 144 towards a corresponding driving shaft 122, thereby causing the mirror body 12 to deflect or tilt. When the optical switch 145 is closed, the liquid 15 returns to an initial state as it cools down, and the corresponding driving shaft 122 returns to its original position.

In another embodiment, the MEMS driving modules 14 can share a single light source 143.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A micro-electro-mechanical system (MEMS) mirror comprising:
a reflective mirror comprising a mirror body and a number of driving shafts, the mirror body comprising a reflective surface, an opposite bottom surface, and a number of side surfaces interconnected between the reflective surface and the bottom surface, the driving shafts extending from the side surfaces and being equidistant from each other around a central axis of the mirror body; and
a number of MEMS driving modules corresponding to each of the driving shafts respectively, each MEMS driving module comprising:
a container comprising a rigid main body defining a cavity, an opening of the cavity, and a through hole communicating with the cavity, the container further comprising a flexible sealing film covering the opening, the flexible sealing film being arranged to face a bottom surface of a corresponding driving shaft adjacent to the bottom surface of the mirror body, the cavity being filled with liquid contacting the sealing film; and
an optical fiber comprising a light incident end arranged toward a light source and a light output end inserted into the through hole, wherein light emitted from the light source enters the optical fiber through the light incident end and out of the optical fiber through the light output end, the liquid in the cavity is heated and expands from the light emitted from the light output end, thereby causing the sealing film to deform and push the corresponding driving shaft causing the mirror body to deflect.

2. The micro-electro-mechanical system mirror (MEMS) of claim 1, further comprising an optical switch, the optical switch is located between the light source and the light incident end to allow or prevent light emitted from the light source entering the light incident end.

3. The micro-electro-mechanical system mirror of claim 2, wherein the MEMS driving modules share a single light source.

4. The MEMS mirror of claim 1, wherein each MEMS driving module further comprises a contact member positioned between the sealing film and the corresponding driving shaft.

5. The MEMS mirror of claim 4, wherein the contact member is made of a rigid material.

6. The micro-electro-mechanical system mirror of claim 4, wherein the contact member has a cylindrical, polygon, ellipsoid, or spherical shape.

7. The MEMS mirror of claim 1, wherein the mirror body is square shaped having four side surfaces, and there is a single driving shaft extending from each of the four side surfaces.

8. The MEMS mirror of claim 7, wherein an extending direction of each driving shaft is substantially perpendicular to and intersects the central axis of the mirror body.

9. A micro-electro-mechanical system (MEMS) reflective device comprising:
a number of micro-electro-mechanical system (MEMS) mirror arranged in an array, each micro-electro-mechanical system mirror comprising:
a reflective mirror comprising a mirror body and a number of driving shafts, the mirror body comprising a reflective surface, an opposite bottom surface, and a number of side surfaces interconnected between the reflective surface and the bottom surface, the driving shafts extending from the side surfaces and being equidistant from each other around a central axis of the mirror body; and
a number of MEMS driving modules corresponding to each of the driving shafts respectively, each MEMS driving module comprising:
a container comprising a rigid main body defining a cavity, an opening of the cavity, and a through hole communicating with the cavity, the container further comprising a flexible sealing film covering the opening, the flexible sealing film being arranged to face a bottom surface of a corresponding driving shaft adjacent to the bottom surface of the mirror body, the cavity being filled with liquid contacting the sealing film; and
an optical fiber comprising a light incident end arranged toward a light source and a light output end inserted into the through hole, wherein light emitted from the light source enters the optical fiber through the light incident end and out of the optical fiber through the light output end, the liquid in the cavity is heated and expands from the light emitted from the light output end, thereby causing the sealing film to deform and push the corresponding driving shaft causing the mirror body to deflect.

10. The micro-electro-mechanical system (MEMS) reflective device of claim 9, wherein each of the MEMS mirror further comprises an optical switch, the optical switch is located between the light source and the light incident end to allow or prevent light emitted from the light source entering the light incident end.

11. The micro-electro-mechanical system reflective device of claim 10, wherein the MEMS driving modules share a single light source.

12. The MEMS reflective device of claim 9, wherein each MEMS driving module further comprises a contact member positioned between the sealing film and the corresponding driving shaft.

13. The MEMS reflective device of claim 12, wherein the contact member is made of a rigid material.

14. The micro-electro-mechanical system reflective device of claim 12, wherein the contact member has a cylindrical, polygon, ellipsoid, or spherical shape.

15. The MEMS reflective device of claim 9, wherein the mirror body is square shaped having four side surfaces, and there is a single driving shaft extending from each of the four side surfaces.

16. The MEMS reflective device of claim 15, wherein an extending direction of each driving shaft is substantially perpendicular to and intersects the central axis of the mirror body.
